(19) United States
(12) Patent Application Publication
(10) Pub. No.: US 2024/0139867 A1
(43) Pub. Date: May 2, 2024

(54) WELDING OPTICAL UNIT FOR THE LASER WELDING OF WORKPIECES, WITH FLEXIBLE SETTING OF THE NUMBER OF AND DISTANCE BETWEEN LASER SPOTS USING CYLINDRICAL LENSES

(71) Applicant: TRUMPF Laser- und Systemtechnik GmbH, Ditzingen (DE)

(72) Inventors: Patrick Haug, Gerlingen (DE); Daniel Flamm, Ludwigsburg (DE)

(21) Appl. No.: 18/409,840

(22) Filed: Jan. 11, 2024

Related U.S. Application Data
(63) Continuation of application No. PCT/EP2022/066898, filed on Jun. 21, 2022.

(30) Foreign Application Priority Data
Jul. 15, 2021 (DE) 102021118390.1

(51) Int. Cl. B23K 26/06; B23K 26/073; B23K 26/08

(52) U.S. Cl. CPC B23K 26/0648; B23K 26/073; B23K 26/0876

(57) ABSTRACT

A welding optical unit includes a collimator for collimating a laser beam, a focusing device for focusing the laser beam toward a workpiece, an adjustable beam shaper configured to shape the laser beam. The beam shaper includes a beam subdivision assembly that includes a cylindrical lens pair comprising two cylindrical lenses with diametrically opposite focal lengths and mutually parallel optical planes. The two cylindrical lenses extend with a curve on at least one side with respect to a common refraction direction perpendicular to the optical planes, and extend translationally invariantly with respect to a common non-refraction direction parallel to the optical planes. The refraction direction and the non-refraction direction extend perpendicularly to the optical axis of the welding optical unit. The welding optical unit further includes a spot distance adjusting device configured to displace the two cylindrical lenses relative to one another with respect to the refraction direction.

### CROSS REFERENCE TO RELATED ΔβPLICATIONS

This application is a continuation of International Application No. PCT/EP2022/066898 (WO 2023/285084 A1), filed on Jun. 21, 2022, and claims benefit to German Patent Application No. DE 10 2021 118 390.1, filed on Jul. 15, 2021. The aforementioned applications are hereby incorporated by reference herein.

### FIELD

Embodiments of the present invention relate to a welding optical unit for a laser beam for the laser welding of workpieces.

### BACKGROUND

Welding is a joining method which enables two workpieces to be permanently connected to one another. Laser welding is usually used if the intention is to carry out welding at a high welding speed, with a narrow and slender weld seam shape and with a low degree of thermal distortion. During laser welding, energy is fed in via a laser beam.

Depending on the welding situation, which is determined in particular by the one or more workpiece materials to be joined and the workpiece geometries, a different laser welding procedure may be advantageous for an optimum welding result. For example, in certain welding situations it may be advantageous to shape the laser beam and subdivide it into multiple partial beams, with the result that multiple laser spots (for example two or four laser spots) act on the workpiece surface; often, there is also an optimum distance between the laser spots. In other welding situations, by contrast, it may be advantageous to use only a single laser spot.

In general, a laser welding machine, and in particular the welding optical unit present on the laser welding machine, which can be used to direct the laser beam onto the workpieces, is designed for a certain welding situation, or welding task. If the welding task changes, in particular if different workpieces (i.e. workpiece types) are to be welded to one another, the laser welding machine is retrofitted, with components of the welding optical unit or else the welding optical unit as a whole being exchanged. This is complex in terms of equipment and time-consuming.

DE 10 2016 124 924 A1 discloses a laser welding apparatus which can be used to weld a seal plate on a housing body of a battery, the housing body and the seal plate consisting of aluminum. A collimated laser beam is conducted via a shaping device, which comprises a diffractive optical element (DOE) with an opening. The DOE can be used to subdivide an incident laser beam into multiple partial beams, for example into four partial beams, which are arranged corresponding to the corners of a square. The DOE can be moved relative to the laser beam. Depending on the overlap of the collimated laser beam with the DOE or its opening, part of the collimated laser beam is subdivided into the partial beams by the DOE, or remains unshaped as it passes through the opening.

This laser welding apparatus makes it possible to modify the number of partial beams. However, the subdivision into the partial beams and the distance between the associated laser spots on the workpieces is defined by the DOE. In addition, the DOE rigidly specifies the number of partial beams formed from the laser beam that is incident on the DOE.

DE 10 2010 003 750 A1 discloses altering the beam profile characteristic of a laser beam by means of a multiclad fiber. Here, a laser beam having a core portion and a ring portion can be generated.

### SUMMARY

Embodiments of the present invention provide a welding optical unit for a laser beam for laser welding of workpieces. The welding optical unit includes a source for providing a laser beam, a collimator for collimating the laser beam incident thereon, a focusing device for focusing the laser beam incident thereon toward a workpiece to be welded, an adjustable beam shaper configured to shape the laser beam incident thereon into a shaped laser beam. The shaped laser beam includes one beam or multiple partial beams depending on an adjustment of the beam shaper, and correspondingly forms one or multiple laser spots on the workpiece to be welded. The beam shaper is arranged in a beam path of the laser beam between the collimator and the focusing device. The beam shaper includes at least one beam subdivision assembly. The at least one beam subdivision assembly includes a cylindrical lens pair comprising two cylindrical lenses with diametrically opposite focal lengths and mutually parallel optical planes. The two cylindrical lenses are arranged one behind the other with respect to an optical axis of the welding optical unit. The two cylindrical lenses of the cylindrical lens pair extend with a curve on at least one side with respect to a common refraction direction perpendicular to the optical planes, and extend translationally invariantly with respect to a common non-refraction direction parallel to the optical planes. The refraction direction and the non-refraction direction extend perpendicularly to the optical axis of the welding optical unit. The welding optical unit further includes a spot distance adjusting device configured to displace the two cylindrical lenses of the cylindrical lens pair relative to one another with respect to the refraction direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of an exemplary optical unit having a beam shaping device comprising a beam subdivision assembly, according to some embodiments;

FIG. 2 shows the welding optical unit from FIG. 1 rotated by 90° about the optical axis, according to some embodiments;

FIG. 3 shows a schematic side view of an exemplary welding optical unit having a beam shaping device comprising two beam subdivision assemblies, according to some embodiments;

FIG. 4 shows the welding optical unit from FIG. 3 rotated by 90° about the optical axis, according to some embodiments;

FIG. 5 schematically depicts the closed-loop control of the power distribution of the laser spots using the welding optical unit from FIG. 3, according to some embodiments;

FIG. 6a shows a schematic illustration, in cross section, of an exemplary 2-in-1 fiber that can be used as a fiber-optic cable and source for the output laser beam for the welding optical unit in FIGS. 1-4, according to some embodiments;

FIG. 6b shows a schematic illustration, in cross section, of an output laser beam that can be generated by the exemplary 2-in-1 fiber from FIG. 6a, with a core portion and a ring portion, according to some embodiments;

FIG. 7a shows, by way of example for the embodiment of FIGS. 1 and 2 and in a schematic plan view of a surface of a workpiece, two laser spots of a shaped laser beam, each having a core portion and a ring portion, according to some embodiments;

FIG. 7b shows, by way of example for the embodiment of FIGS. 3 and 4 and in a schematic plan view of a surface of a workpiece, four laser spots of a shaped laser beam, each having a core portion and a ring portion, according to some embodiments;

FIG. 8a shows an image, from an experiment, of a single laser spot generated by a welding optical unit similar to that in FIG. 3, according to some embodiments;

FIG. 8b shows an image, from an experiment, of two laser spots generated by a welding optical unit similar to that in FIG. 3, according to some embodiments;

FIG. 8c shows an image, from an experiment, of two laser spots generated by a welding optical unit similar to that in FIG. 3, which are further apart than in FIG. 8b, according to some embodiments;

FIG. 9a shows an image, from an experiment, of four laser spots generated by the welding optical unit of FIG. 3, each having a core portion and a ring portion in a rectangular formation, according to some embodiments; and

FIG. 9b shows an image, from an experiment, of four laser spots generated by the welding optical unit of FIG. 3, each having a core portion and a ring portion in a square formation, according to some embodiments.

### DETAILED DESCRIPTION

Embodiments of the invention provide a welding optical unit which can be used to easily and flexibly shape a beam, and in particular to flexibly set a number of and a distance between generated laser spots.

According to embodiments of the invention, a welding optical unit for a laser beam for laser welding of workpieces includes
a source for an output laser beam,
a collimation device for collimating a laser beam incident on the collimation device,
a focusing device for focusing a laser beam incident on the focusing device in the direction of a workpiece to be welded,
and an adjustable beam shaping device, which makes it possible to shape a laser beam incident on the beam shaping device into a shaped laser beam, it being possible for the shaped laser beam to comprise one beam or multiple partial beams depending on the adjustment of the beam shaping device, and correspondingly for one or more laser spots to be generated on the workpiece to be welded,
in particular with the beam shaping device being arranged in the beam path of the laser beam between the collimation device and the focusing device.
the beam shaping device comprises at least one beam subdivision assembly, each beam subdivision assembly having:
a cylindrical lens pair, comprising two cylindrical lenses with diametrically opposite focal lengths and mutually parallel optical planes,
the cylindrical lenses being arranged one behind the other with respect to an optical axis of the welding optical unit,
the two cylindrical lenses of the cylindrical lens pair extending with a curve on at least one side with respect to a common refraction direction, which is perpendicular to the optical planes, and extending translationally invariantly with respect to a common non-refraction direction, which extends parallel to the optical planes,
and the refraction direction and the non-refraction direction extending perpendicularly in relation to the optical axis of the welding optical unit,
and a spot distance adjusting device, which makes it possible to displace the two cylindrical lenses of the cylindrical lens pair relative to one another with respect to the refraction direction.

According to some embodiments, one or more beam subdivision assemblies are arranged in the beam path of the laser beam which is directed onto the workpieces to be welded. A respective beam subdivision assembly comprises a cylindrical lens pair with diametrically opposite focal lengths, which overlaps part of the beam cross section of the laser beam and does not overlap another part of the beam cross section. The optical planes of the cylindrical lenses are aligned parallel to an optical axis of the welding optical unit and parallel to one another.

In a home position of the cylindrical lenses of the cylindrical lens pair, in which their optical planes coincide, the effects of the two cylindrical lenses counteract each other, and the laser beam (or the proportion thereof that overlaps the cylindrical lens pair) that is incident on the cylindrical lens pair remains unmodified and in particular undeflected.

If, however, the cylindrical lenses are displaced relative to one another by means of the spot distance adjusting device in the common refraction direction, along which the cylindrical lenses of the cylindrical lens pair each extend with a curve, the optical planes of the cylindrical lenses move away from one another. In such a deflection position, the laser beam (or the proportion thereof that overlaps the cylindrical lens pair) that is incident on the cylindrical lens pair is deflected transversely to the optical axis of the welding optical unit (that is to say is pivoted away from the optical axis of the welding optical unit) by the cylindrical lens pair. As a result, the beam proportion of the laser beam that overlaps the cylindrical lens pair forms a laser spot downstream of the focusing device that is displaced relative to a (undeflected) laser spot that results from the beam proportion that does not overlap the cylindrical lens pair. The mutual displacement of the laser spots is proportional to the mutual displacement of the cylindrical lenses in the common refraction direction.

It should be noted that, when the spot distances are adjusted by means of the spot distance adjusting device, the shape (in particular the size) of the laser spots does not change, by contrast to the case in which the imaging ratio is modified. Correspondingly, laser spot overlaps can also be flexibly set.

According to embodiments of the invention, a respective beam subdivision assembly can be used to conjointly generate one beam or two partial beams from an incident laser beam depending on the adjustment position, with a distance between the partial beams being settable via the extent of displacement of the cylindrical lenses relative to one another. Connecting multiple beam subdivision assemblies one behind another makes it possible to increase (multiply) the number of partial beams that can be created; with two beam subdivision assembles, for example, it is possible to flexibly set a number of 1, 2 or 4 laser spots, with the option of setting the spot distances in pairs.

Correspondingly, the welding optical unit according to embodiments of the invention, or its beam shaping device, which has one or more beam subdivision assemblies, can be used to very flexibly shape the laser beam. It is very easily possible to adapt the welding optical unit to a forthcoming welding situation.

According to embodiments of the invention, the laser welding procedure can be optimally adapted to a selected welding situation, in particular the workpiece materials and workpiece geometries, with the result that it is possible to achieve a high quality of the welding and efficiency of the welding process or of the associated laser welding machine, in particular with little welding spatter and/or few welding errors (in particular pores) and/or high reliability in terms of the process and/or good media impermeability of the weld seam and/or high welding speed. In this respect, the welding optical unit can be adapted easily by way of respective spot distance adjusting devices, in particular without it being necessary to exchange components of the welding optical unit. In addition, it is possible to modify the procedure (in particular the number of laser spots and/or the distances between the laser spots) even during ongoing laser welding processing of workpieces that are welded together (that is to say, while the weld contour to be welded is being traversed). For example, it is then possible to modify the number of laser spots or modify the distance between spots in certain critical regions along the welding contour that is to be welded, for example along curves.

The one or more beam subdivision assemblies are preferably arranged between the collimation device and the focusing device (that is to say in the collimated laser beam); alternatively, it is also possible, for example, for the arrangement to be just upstream of the collimation device or just downstream of the focusing device. The spot distance adjusting device is typically automatedly adjustable by a motor, preferably by way of a closed-loop control system. Workpieces can be welded by means of the welding optical unit according to embodiments of the invention in particular with a butt joint or a lap weld. In this respect, welded connections in the form of partial penetration or full penetration welds are possible. The welding is typically carried out in a deep penetration welding regime.

A preferred embodiment of the welding optical unit according to the invention provides that the beam shaping device comprises two beam subdivision assemblies,

and that the refraction directions of the two cylindrical lens pairs of the two beam subdivision assemblies extend crossing one another. Connecting two beam subdivision assemblies one behind another with crossed refraction directions according to embodiments of the invention makes it possible to flexibly choose between 1, 2 or 4 laser spots for processing the workpieces, and the spot distances can be set flexibly in pairs and independently of one another.

In a preferred refinement of this embodiment, the refraction directions of the two beam subdivision assemblies cross at an angle of 90°. This makes it possible to set up rectangular, and in particular also square, laser spot arrangements, which are frequently desirable in practice. Square arrangements exhibit a low directional dependence of the welding process.

Also preferred is an embodiment which provides that, for a respective cylindrical lens pair, it holds true that the two cylindrical lenses are arranged such that they can overlap part of the beam cross section of the laser beam, in particular collimated laser beam, and cannot overlap another part of the beam cross section of the laser beam, in particular collimated laser beam. This has the effect that part of the laser beam can be deflected by the cylindrical lens pair (irrespective of the adjustment position), and part of the laser beam is not deflected by the cylindrical lens pair (irrespective of the adjustment position). In this way, subdivision into two partial beams is fundamentally enabled. The placement of the cylindrical lens pair in the collimated laser beam makes it possible to shape the beam easily and precisely.

Also advantageous is an embodiment in which, in the case of a respective beam subdivision assembly, the spot distance adjusting device can assume at least the following adjustment positions:
a home position, in which the optical planes of the cylindrical lenses of the cylindrical lens pair coincide, and
a deflection position, in which the optical planes of the cylindrical lenses of the cylindrical lens pair are arranged offset in relation to one another with respect to the refraction direction. In the home position, there is no modification of the laser beam (or the beam proportion which is incident on the cylindrical lens pair) overall by the cylindrical lenses of the cylindrical lens pair; the cylindrical lens pair is invisible to the laser beam, or has virtually no optical effect on the laser beam. Correspondingly, a subdivision into partial beams can be deselected by virtue of the home position. One beam remains, since the beam proportions propagate through the cylindrical lens pair and at the cylindrical pair in the same way. In the deflection position, by contrast, that proportion of the laser beam that is incident on the cylindrical lens pair is deflected, as a result of which a subdivision of the laser beam into two partial beams can be selected. The beam proportions propagate differently through the cylindrical lens pair and past the cylindrical lens pair.

Preferred is a refinement of this embodiment in which the spot distance adjusting device can assume multiple different deflection positions, in which the optical planes of the cylindrical lenses are arranged offset in relation to one another to different extents with respect to the refraction direction,
in particular with it being possible to continuously set different adjustment positions of the spot distance adjusting device in an adjustment range. Correspondingly, multiple different spot distances between the laser spots can be set. Distances between laser spots can be continuously set with a continuous adjustment range. This makes it possible to use the welding optical unit flexibly.

A preferred embodiment provides that each beam subdivision assembly also has:
a spot intensity adjusting device, which makes it possible to displace, in particular conjointly displace, the two cylindrical lenses of the cylindrical lens pair with respect to the non-refraction direction. Displacing the cylindrical lens pair with respect to the non-refraction direction makes it possible to easily modify the proportion of the beam cross section of the laser beam that overlaps the cylindrical lens pair in relation to the proportion of the beam cross section that does not overlap the cylindrical lens pair. As a result, a distribution of the energy of the (output) laser beam among a beam proportion displaced by means of the cylindrical lens pair (“displaced laser spot(s)”) and a beam proportion not influenced by means of the cylindrical lens pair (“undisplaced laser spot(s)”) can be flexibly selected, this resulting in corresponding intensities of the laser spots. The spot intensity adjusting device is typically automatedly adjustable by a motor.

What is advantageous is a refinement of this embodiment in which, in the case of a respective beam subdivision assembly, the two cylindrical lenses are arranged on a common carriage, it being possible to move the common carriage by means of the spot intensity adjusting device on the welding optical unit with respect to the non-refraction direction, and it being possible to move one of the cylindrical lenses by means of the spot distance adjusting device on the common carriage with respect to the refraction direction. The common carriage makes it possible to jointly move the two cylinder lenses easily. The distances between spots and the intensity distribution can be set independently of one another and with low complexity.

Another embodiment of the welding optical unit provides that the source for the output laser beam is formed by a fiber end of a fiber-optic cable, and that a fiber end displacement apparatus which can be used to displace the fiber end transversely to the collimation device (or to the optical axis of the welding optical unit) is present. The fiber end displacement apparatus, as an alternative or in addition to a spot intensity adjusting device, makes it possible to modify the proportion of the beam cross section of the laser beam that overlaps the respective cylindrical lens pair in relation to the proportion of the beam cross section that does not overlap the cylindrical lens pair and thus modify the intensity of the laser spots. The fiber end displacement apparatus may be integrated in a fiber connector. In general, the movement travel set up for the fiber end can be relatively small, with the result that the possible modifications to the intensities of the laser spots owing to displacement of the fiber are comparatively low; however, the intensities of the laser spots can be adjusted very precisely.

Also preferable is an embodiment in which the source for the output laser beam is a fiber end of a multifiber, from which the output laser beam can emerge in the form of a preshaped laser beam with a core portion and a ring portion,
in particular with the multifiber being a 2-in-1 fiber, from the fiber end of which the output laser beam can emerge. The preshaped laser beam with a core portion and a ring portion (a considerably higher mean power density generally prevailing in the core part than in the ring part, usually by at least a factor of 4) can in many welding situations contribute to maintaining a smooth melt pool, and to improving the quality of the welding. It should be noted that the one or more laser spots used on the workpiece then also have a corresponding core portion and ring portion. By displacing laser spots, the laser spots, and in particular the ring portions, can be flexibly positioned and moved close to one another, and can be arranged touching one another or overlapping one another if desired. The multifiber has a core fiber and at least one ring fiber which annularly surrounds the core fiber, exactly one ring fiber in the case of the 2-in-1 fiber. The core portion results from the core fiber, and the ring portion results from the ring fiber or from the multiple ring fibers as a whole.

Also preferred is an embodiment in which the collimation device comprises at least one, preferably exactly one, collimation lens. This is easy to set up and has proven successful in practice.

Likewise preferred is an embodiment in which the focusing device comprises at least one, preferably exactly one, focusing lens. This is likewise easy to set up and has proven successful in practice.

Embodiments of the present invention also relate to the use of an above-described welding optical unit, wherein
an output laser beam is fed into the welding optical unit, a shaped laser beam is focused in the direction of a workpiece by the welding optical unit, and the shaped laser beam traverses a welding contour on the workpiece,
and in that, while the welding contour is being traversed, the adjustment position of the spot distance adjusting device is adjusted in the case of at least one beam subdivision assembly. This makes it possible to adapt the procedure (i.e. the shaping of the laser beam), while a welding contour (which corresponds to the weld seam to be produced) is being traversed, at critical points, for example where narrow radii must be passed through, in order to optimize the welding process. For example, the spot distance along curves can be reduced in comparison with straight sections of the welding contour. It is also possible to readjust the procedure (in particular the setting of the distances between spots and optionally the number of spots) while the welding contour is being traversed in a closed-loop control system.

Also advantageous is a variant of the above use according to embodiments of the invention, which provides
that each beam subdivision assembly also has:
   a spot intensity adjusting device, which makes it possible to displace, in particular conjointly displace, the two cylindrical lenses of the cylindrical lens pair with respect to the non-refraction direction, and wherein, while the welding contour is being traversed, the adjustment position of the spot intensity adjusting device is adjusted in the case of at least one beam subdivision assembly. This makes it possible to further refine and optimize the procedure while the welding contour is being traversed. For example, the intensity can be reduced in leading laser spots (with respect to the local feed direction/welding direction) and increased in trailing laser spots along curves in comparison with straight sections of the welding contour.

Another variant provides that the source for the output laser beam is formed by a fiber end of a fiber-optic cable, that a fiber end displacement apparatus which can be used to displace the fiber end transversely to the collimation device (or to the optical axis of the welding optical unit) is present, and that the position of the fiber end is displaced while the welding contour is being traversed. This likewise makes it possible to further refine and optimize the procedure while the welding contour is being traversed. Transverse displacement of the fiber end can be used to displace the beam cross section of the laser beam relative to the two cylindrical lenses of a respective cylindrical lens pair and thus modify the intensity of the laser spots.

Embodiments of the present invention also relate to the use of an above-described welding optical unit, wherein
different workpieces are welded one after another using the welding optical unit, in each case an output laser beam being fed into the welding optical unit, a shaped laser beam being focused in the direction of a workpiece by the welding optical unit, and the shaped laser beam traversing a welding contour on the workpiece,
and in that the adjustment position of the spot distance adjusting device is adjusted between the welding operations for the different workpieces. Adjusting the spot distance adjusting device makes it possible to adapt the procedure to different workpieces (i.e. different sets of workpieces to be welded), in particular their different materials and/or different workpiece geometries, during the welding operation with low complexity, and thus optimize the welding process in the event of a type change of workpieces to be welded. In particular, in the event of a type change, the number of laser spots used can be modified and/or a distance between spots can be modified. It should be noted that, if the same workpieces (i.e. the same sets of workpieces to be welded) are welded one after another, the adjustment position is generally not modified when the workpieces are changed.

What is advantageous is a variant of the above use according to embodiments of the invention which provides that each beam subdivision assembly also has:
a spot intensity adjusting device, which makes it possible to displace, in particular conjointly displace, the two cylindrical lenses of the cylindrical lens pair with respect to the non-refraction direction, and wherein the adjustment position of the spot intensity adjusting device is adjusted between the welding operations for the different workpieces. This makes it possible to even more finely adapt and further optimize the welding process during a type change of the workpieces to be welded.

Another variant provides that the source for the output laser beam is formed by a fiber end of a fiber-optic cable, that a fiber end displacement apparatus which can be used to displace the fiber end transversely to the collimation device (or to the optical axis of the welding optical unit) is present, and that the position of the fiber end is displaced between the welding operations for the different workpieces. This likewise makes it possible to even more finely adapt and further optimize the welding process during a type change of the workpieces to be welded. Transverse displacement of the fiber end can be used to displace the beam cross section of the laser beam relative to the two cylindrical lenses of a respective cylindrical lens pair and thus modify the intensity of the laser spots.

Further advantages of the invention will emerge from the description and the drawing. Similarly, according to the invention, the features mentioned above and those yet to be explained further may be used in each case individually or together in any desired combinations. The embodiments shown and described should not be understood as an exhaustive enumeration, but rather are of an exemplary character for outlining the invention.

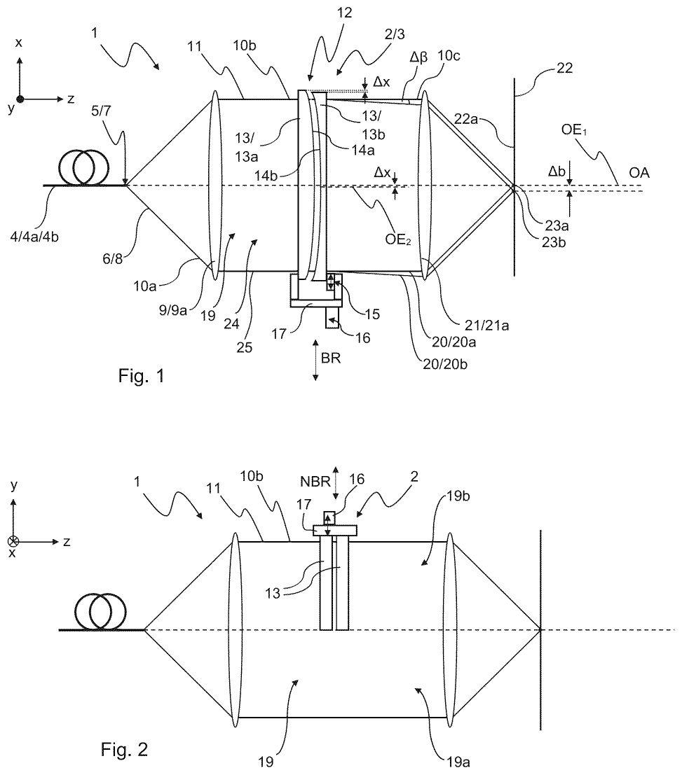

FIG. 1 shows a schematic side view of an exemplary embodiment of a welding optical unit 1 according to embodiments of the invention having a beam shaping device 2 comprising a beam subdivision assembly 3. The coordinate system is selected such that the x axis points upward, the y axis points out of the plane of the drawing, and the z axis points to the right. An optical axis OA of the welding optical unit 1 extends in the direction of the z axis.

The welding optical unit 1 comprises a source 5 for an output laser beam 6, the source 5 being formed by a fiber end 7 of a fiber-optic cable 4 in this case. In the form shown here, the fiber-optic cable 4 selected is a multifiber 4a, more specifically a 2-in-1 fiber 4b (in this respect, see FIG. 6a). As an alternative, and not shown here, the fiber-optic cable 4 selected can also be a single fiber. In this case, the output laser beam 6 emerges from the fiber end 7 of the multifiber 4a in the form of a preshaped laser beam 8, the preshaped laser beam 8 having a core portion and a ring portion (in this respect, see FIG. 6b).

The fiber end 7 is in the focus of a collimation device 9, in this case a collimation lens 9a. In an embodiment not shown here, the collimation device 9 may also comprise multiple focusing lenses 9a. The preshaped laser beam 8 is collimated in the form of an incident laser beam 10a on the collimation lens 9a and perpetuated in the form of a collimated laser beam 11. The collimated laser beam 11 impinges on the adjustable beam shaping device 2 in the form of an incident laser beam 10b.

In this case, the beam shaping device 2 is formed with only one beam subdivision assembly 3. The beam subdivision assembly 3 has a cylindrical lens pair 12, which comprises two cylindrical lenses 13 with focal lengths ±f_{zy1}. A first cylindrical lens 13a with the focal length +f_{zy1} has a convexly curved surface 14a on one side (front side); the other side (rear side) has a flat form here. A second cylindrical lens 13b with the focal length −f_{zy1} has a concavely curved surface 14b on one side (rear side); the other side (front side) has a flat form here. The two focal lengths have the same magnitude, but opposite signs. The cylindrical lenses 13a, 13b thus have diametrically opposite focal lengths. The optical planes OE₁, OE₂ of the cylindrical lenses 13a, 13b (which in this case are perpendicular to the plane of the drawing of FIG. 1) are parallel to one another. A common refraction direction BR of the cylindrical lenses 13 in this case extends in the direction of the x axis and thus perpendicularly in relation to the optical planes OE₁, OE₂ and the optical axis OA. The cylindrical lenses 13 extend with a curve in the refraction direction BR. A common non-refraction direction NBR of the cylindrical lenses 13 in this case extends in the direction of the y axis and thus parallel to the optical planes OE₁, OE₂ and perpendicularly in relation to the optical axis OA. The cylindrical lenses 13 extend translationally invariantly in the non-refraction direction NBR (in this respect, see also FIG. 2). The cylindrical lenses 13 are arranged one behind another with respect to the optical axis OA. In another embodiment which is not shown, the cylindrical lenses 13a, 13b may also have a curved surface on either side.

The beam subdivision assembly 3 furthermore has a spot distance adjusting device 15 and, in the embodiment shown here, also has a spot intensity adjusting device 16. The two lenses 13a, 13b are arranged on a common carriage 17, and in the embodiment shown the first lens 13a is arranged stationarily on the common carriage 17 and the second lens 13b can be moved in the x direction by means of the spot distance adjusting device 15. The spot distance adjusting device 15 is arranged on the common carriage 17 for this. The common carriage 17 (together with the lenses 13a, 13b) in turn can be moved in the y direction with respect to the rest of the welding optical unit 1 by way of the spot intensity adjusting device 16 (cf. FIG. 2). The spot distance adjusting device 15 can thus be used to displace the two cylindrical lenses 13 of the cylindrical lens pair 12 relative to one another with respect to the refraction direction BR (in this case the x direction), and the spot intensity adjusting device 16 can be used to displace the two cylindrical lenses 13 of the cylindrical lens pair 12 with respect to the non-refraction direction NBR (in this case the y direction). In the embodiment shown here, the cylindrical lenses 13 are displaced together by means of the spot intensity adjusting device 16. In an embodiment which is not shown here, it is also possible for the cylindrical lenses 13a, 13b to be able to be displaced in the y direction individually (it nevertheless being the case that in general the same displacement paths in the y direction are used).

In the situation shown in FIG. 1, the adjustment position assumed by the spot distance adjusting device 15 is a deflection position. The second cylindrical lens 13b was displaced from a home position, in which the optical planes OE₁ and OE₂ coincide, in the x direction by a length Δx. The optical planes OE₁, OE₂ of the cylindrical lenses 13a, 13b are then arranged correspondingly offset by Δx in relation to one another with respect to the refraction direction BR in FIG. 1. In the embodiment shown here, it is possible to set different deflection positions of the second lens 13b with respect to the x direction within an adjustment range of the spot distance adjusting device 15. The optical planes OE₁, OE₂ of the cylindrical lenses 13a, 13b may be at different distances from one another with respect to the refraction direction BR corresponding to the respective deflection position of the spot distance adjusting device 15. The different deflection positions can be set continuously in the embodiment shown here. As an alternative, and not shown here, the different adjustment positions can also be set in discrete steps. The spot distance adjusting device 15 can furthermore also be used to reach the home position, in which the optical planes OE₁, OE₂ of the cylindrical lenses 13a, 13b coincide (not illustrated in more detail here).

In the embodiment shown here, the collimated laser beam 11 impinges on the adjustable beam shaping device 2 in the form of an incident laser beam 10b. Here, a beam cross section 19 of the collimated laser beam 11 lies completely within the region of the cylindrical lenses 13 in the direction of the x axis. The cylindrical lenses 13 are arranged in the direction of the y axis such that they overlap part of the beam cross section 19 of the collimated laser beam 11. The cylindrical lenses 13 do not overlap another part of the beam cross section 19 of the collimated laser beam 11 (in this respect, see FIG. 2).

The collimated laser beam 11 is shaped at the beam shaping device 2. Owing to the mutually displaced cylindrical lenses 13a, 13b, that part of the collimated laser beam 11 that impinges on the cylindrical lens pair 12 undergoes a deflection. Here, an angular offset Δβ corresponding to this deflection is approximately the same as the quotient of the length Δx and the focal length f_{zy1} (that is Δβ≈Δx/f_{zy1}). Another part of the collimated laser beam 11, which does not impinge on the cylindrical lens pair 12, remains undeflected. The laser beam 20 shaped in this way correspondingly comprises two partial beams, specifically the deflected partial beam 20b and the undeflected partial beam 20a.

The welding optical unit 1 also comprises a focusing device 21, in this case a focusing lens 21a with a focal length f_{F}. In an embodiment not shown here, the focusing device 21 may also comprise multiple focusing lenses 9a. The shaped laser beam 20 impinges on the focusing lens 21a in the form of an incident laser beam 10c and is focused in the direction of a workpiece 22 to be welded. The focused, shaped laser beam 20 then generates two laser spots 23a, 23b on a surface 22a of the workpiece 22; in the embodiment shown here, the shaped laser beam 20 is focused onto the surface of the workpiece 22. A spatial offset Δb between the two laser spots 23a, 23b is approximately the same as the product of the focal length f_{F} and the angular offset Δβ (that is Δb=f_{F}·Δβ=f_{F}·Δx/f_{zy1}). In the embodiment shown here, it is possible to increase or decrease the spatial offset Δb by displacing the cylindrical lens 13b with respect to the x direction. The spatial offset Δb between the two laser spots 23 then increases or decreases, and the laser spots 23a, 23b move further apart or closer together, corresponding to the displacement.

In the embodiment shown here, the beam shaping device 2 is in a beam path 24 of the laser beam 25 between the collimation device 9 and the focusing device 21. In other embodiments which are not shown here, it is alternatively possible for the beam shaping device 2 to be arranged between the source 5 of the output laser beam 6 and the collimation device 9 (typically close to the latter), or for the beam shaping device 2 to be arranged downstream of the focusing device 21 (and typically close to the latter).

FIG. 2 shows the welding optical unit 1 of FIG. 1 rotated by 90°. In FIG. 2, the coordinate system is then aligned such that the x axis points out of the plane of the drawing, the y axis points upward, and the z axis points to the right.

In the embodiment shown here, the collimated laser beam 11 impinges on the adjustable beam shaping device 2 in the form of an incident laser beam 10b. Here, the beam cross section 19 of the collimated laser beam 11 lies completely within the region of the cylindrical lenses 13 in the direction of the x axis (see FIG. 1). The cylindrical lenses 13 are arranged in the direction of the y axis such that they overlap that part 19b (the upper part in FIG. 2) of the beam cross section 19 of the collimated laser beam 11 that corresponds to approximately half the beam cross section 19 of the collimated laser beam 11 here. The cylindrical lenses 13 do not overlap the other part 19a (the lower part in FIG. 2) of the beam cross section 19 of the collimated laser beam 11, which corresponds to approximately (the remaining) half of the beam cross section 19 of the collimated laser beam 11 here. The deflected partial beam (20b in FIG. 1) results from the upper part 19b and the undeflected partial beam (20a in FIG. 1) results from the lower part 19a.

It should be noted that, with the cylindrical lenses 13 in the home position (where Δx=0), there would be no deflection in the upper part 19b of the laser beam and correspondingly only one laser spot would be generated (not illustrated in more detail).

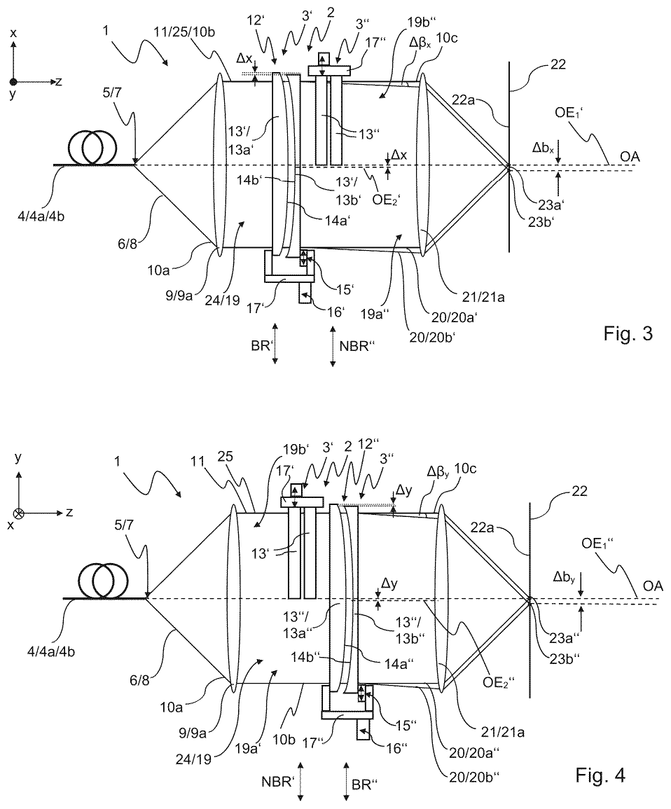

FIG. 3 shows a schematic side view of an exemplary embodiment of a welding optical unit 1 according to embodiments of the invention having the beam shaping device 2 comprising two beam subdivision assemblies 3′, 3″. The coordinate system is selected such that the x axis points upward, the y axis points out of the plane of the drawing, and the z axis points to the right. The optical axis OA of the welding optical unit 1 extends in the direction of the z axis.

The welding optical unit 1 comprises the source 5 for the output laser beam 6, the source 5 being formed by the fiber end 7 of the fiber-optic cable 4. In the embodiment shown here, the fiber-optic cable 4 selected is the multifiber 4a, more specifically the 2-in-1 fiber 4b (in this respect, see FIG. 6a). As an alternative, and not shown here, the fiber-optic cable 4 selected can also be a single fiber. In this case, the output laser beam 6 emerges from the fiber end 7 of the multifiber 4a in the form of the preshaped laser beam 8, the preshaped laser beam 8 having a core portion and a ring portion (in this respect, see FIG. 6b).

The fiber end 7 is in the focus of the collimation device 9, in this case the collimation lens 9a. In an embodiment not shown here, the collimation device 9 may comprise multiple focusing lenses 9a. The preshaped laser beam 8 is collimated in the form of an incident laser beam 10a on the collimation lens 9a and perpetuated in the form of a collimated laser beam 11. The collimated laser beam 11 impinges on the adjustable beam shaping device 2 in the form of an incident laser beam 10b.

In this case, the beam shaping device 2 is formed with two beam subdivision assemblies 3′, 3″. In the embodiment shown here, the beam subdivision assemblies 3′, 3″ cross at an angle of 90°. The beam subdivision assembly 3′ is described in detail predominantly with reference to FIG. 3, and the beam subdivision assembly 3″ is described in detail predominantly with reference to FIG. 4, with FIG. 4 showing the welding optical unit of FIG. 3 rotated by 90° about the z axis.

First beam subdivision assembly 3′ (FIG. 3):

The first beam subdivision assembly 3′ has a cylindrical lens pair 12′, which comprises two cylindrical lenses 13′ with focal lengths ±f_{zy1}′. A first cylindrical lens 13a′ with the focal length +f_{zy1}′ has a convexly curved surface 14a′ on one side (front side); the other side (rear side) has a flat form here. The second cylindrical lens 13b′ with the focal length −f_{zy1}′ has a concavely curved surface 14b′ on one side (rear side); the other side (front side) has a flat form here. The two focal lengths have the same magnitude, but opposite signs. The cylindrical lenses 13a′, 13b′ thus have diametrically opposite focal lengths. The optical planes OE₁′, OE₂′ of the cylindrical lenses 13a′, 13b′ (which in this case are perpendicular to the plane of the drawing of FIG. 3) are parallel to one another. A common refraction direction BR′ of the cylindrical lenses 13′ in this case extends in the direction of the x axis and thus perpendicularly in relation to the optical planes OE₁′, OE₂′ and the optical axis OA. The cylindrical lenses 13′ extend with a curve in the refraction direction BR′. A common non-refraction direction NBR′ of the cylindrical lenses 13′ in this case extends in the direction of the y axis and thus parallel to the optical planes OE₁′, OE₂′ and perpendicularly in relation to the optical axis OA. The cylindrical lenses 13′ extend translationally invariantly in the non-refraction direction NBR′ (in this respect, see also FIG. 4). The cylindrical lenses 13′ are arranged one behind another with respect to the optical axis OA. In another embodiment which is not shown, the cylindrical lenses 13a′, 13b′ may have a curved surface on either side.

The first beam subdivision assembly 3′ furthermore has a spot distance adjusting device 15′ and, in the embodiment shown here, also has a spot intensity adjusting device 16′. The two lenses 13a′, 13b′ are arranged on a common carriage 17′, and in the embodiment shown the first lens 13a′ is arranged stationarily on the common carriage 17′ and the second lens 13b′ can be moved in the x direction by means of the spot distance adjusting device 15′. The spot distance adjusting device 15′ is arranged on the common carriage 17′ for this. The common carriage 17′ (together with the lenses 13a′, 13b′) in turn can be moved in the y direction with respect to the rest of the welding optical unit 1 by way of the spot intensity adjusting device 16′ (in this respect, see also FIG. 4). The spot distance adjusting device 15′ can thus be used to displace the two cylindrical lenses 13′ of the cylindrical lens pair 12′ relative to one another with respect to the refraction direction BR′ (in this case the x direction), and the spot intensity adjusting device 16′ can be used to displace the two cylindrical lenses 13′ of the cylindrical lens pair 12′ with respect to the non-refraction direction NBR′ (in this case the y direction). In the embodiment shown here, the cylindrical lenses 13′ are displaced together by means of the spot intensity adjusting device 16′. In an embodiment which is not shown here, it is also possible for the cylindrical lenses 13a′, 13b′ to be able to be displaced in the y direction individually (it nevertheless being the case that in general the same displacement paths in the y direction are used).

In the situation shown here, the adjustment position assumed by the spot distance adjusting device 15′ is a deflection position. The second cylindrical lens 13b′ was displaced from a home position, in which the optical planes OE₁′ and OE₂′ coincide, in the x direction by the length Δx. The optical planes OE₁′, OE₂′ of the cylindrical lenses 13a′, 13b′ are then arranged correspondingly offset by Δx in relation to one another with respect to the refraction direction BR′ in FIG. 3. In the embodiment shown here, it is possible to set different deflection positions of the second lens 13b′ with respect to the x direction within an adjustment range of the spot distance adjusting device 15′. The optical planes OE₁′, OE₂′ of the cylindrical lenses 13a′, 13b′ may be at different distances from one another with respect to the refraction direction BR′ corresponding to the respective deflection position of the spot distance adjusting device 15′. The different deflection positions can be set continuously in the embodiment shown here. As an alternative, and not shown here, the different adjustment positions can also be set in discrete steps. The spot distance adjusting device 15′ can furthermore also be used to reach the home position, in which the optical planes OE₁′, OE₂′ of the cylindrical lenses 13a′, 13b′ coincide (not illustrated in more detail here).

In the embodiment shown here, the collimated laser beam 11 impinges on the adjustable beam shaping device 2 in the form of an incident laser beam 10b. Here, the beam cross section 19 of the collimated laser beam 11 lies completely within the region of the cylindrical lenses 13′ in the direction of the x axis. The cylindrical lenses 13′ are arranged in the direction of the y axis such that they overlap part of the beam cross section 19 of the collimated laser beam 11. The cylindrical lenses 13′ do not overlap another part of the beam cross section 19 of the collimated laser beam 11 (in this respect, see FIG. 4).

Cylindrical lenses 13″ of the second beam subdivision assembly 3″ are arranged in the direction of the x axis such that they overlap that part 19b″ (the upper part in FIG. 3) of the beam cross section 19 of the collimated (and partially shaped) laser beam 11 that corresponds to approximately half the beam cross section 19 of the collimated laser beam 11 here. The cylindrical lenses 13″ do not overlap the other part 19a″ (the lower part in FIG. 3) of the beam cross section 19 of the collimated laser beam 11, which corresponds to approximately (the remaining) half of the beam cross section 19 of the collimated laser beam 11 here. A deflected partial beam (20b″ in FIG. 4) results from the upper part 19b″ and an undeflected partial beam (20a″ in FIG. 4) results from the lower part 19a″.

It should be noted that, with the cylindrical lenses 13″ in the home position (where Δy=0), there would be no deflection in the upper part 19b″ of the laser beam 25.

The collimated laser beam 11 is shaped at the beam shaping device 2. Owing to the mutually displaced cylindrical lenses 13a′, 13b′, that part of the collimated laser beam 11 that impinges on the cylindrical lens pair 12′ undergoes a deflection. Here, an angular offset Δβₓ corresponding to this deflection is approximately the same as the quotient of the length Δx and the focal length f_{zy1}′ (that is Δβₓ≈Δx/f_{zy1}′). Another part of the collimated laser beam 11, which does not impinge on the cylindrical lens pair 12′, remains undeflected (with respect to the cylindrical lenses 13′ of the left-hand cylindrical lens pair 12′). The laser beam 20 shaped in this way correspondingly (in the projection of FIG. 3) comprises two partial beams, specifically the deflected partial beam 20a′ and the undeflected partial beam 20b′. To further shape the shaped laser beam 20 using the cylindrical lenses 13″ of the right-hand cylindrical lens pair 12″, see below.

The welding optical unit 1 also comprises the focusing device 21, in this case the focusing lens 21a with the focal length f_{F}. In an embodiment not shown here, the focusing device 21 may also comprise multiple focusing lenses 9a. The shaped laser beam 20 impinges on the focusing lens 21a in the form of an incident laser beam 10c and is focused in the direction of the workpiece 22 to be welded. The focused, shaped laser beam 20 then generates multiple laser spots; two laser spots 23a′, 23b′ can be seen on the surface 22a of the workpiece 22 in the projection of FIG. 3. In the embodiment shown, the shaped laser beam 20 is focused onto the surface of the workpiece 22. A spatial offset Δbₓ between the two laser spots 23a′, 23b′ is approximately the same as the product of the focal length f_{F} and the angular offset Δβₓ (that is Δbₓ=f_{F}·Δβx=f_{F}Δx/f_{zy1}′). In the embodiment shown here, it is possible to increase to decrease the spatial offset Δbₓ by displacing the cylindrical lens 13b′ with respect to the x direction. The spatial offset Δbₓ between the two laser spots 23a′, 23b′ then increases or decreases, and the laser spots 23a′, 23b′ move further apart or closer together, corresponding to the displacement.

Second Beam Subdivision Assembly 3″(FIG. 4):

FIG. 4 shows the welding optical unit 1 of FIG. 3 rotated by 90°. In FIG. 4, the coordinate system is then aligned such that the y axis points upward, the x axis points into the plane of the drawing, and the z axis points to the right.

The second beam subdivision assembly 3″ has a cylindrical lens pair 12″, which comprises two cylindrical lenses 13″ with focal lengths ±f_{zy1}. A first cylindrical lens 13a″ with the focal length +f_{zy1}″ has a convexly curved surface 14a″ on one side (front side); the other side (rear side) has a flat form here. A second cylindrical lens 13b″ with the focal length −f_{zy1}″ has a concavely curved surface 14b″ on one side (rear side); the other side (front side) has a flat form here. The two focal lengths have the same magnitude, but opposite signs. The cylindrical lenses 13a″, 13b″ thus have diametrically opposite focal lengths. It should be noted that the chosen focal lengths of the different cylindrical lens pairs 12′, 12″ can be the same or different. The optical planes OE₁″, OE₂″ of the cylindrical lenses 13a″, 13b″ (which in this case are perpendicular to the plane of the drawing of FIG. 4) are parallel to one another. A common refraction direction BR″ of the cylindrical lenses 13″ in this case extends in the direction of the y axis and thus perpendicularly in relation to the optical planes OE₁″, OE₂″ and the optical axis OA. The cylindrical lenses 13″ extend with a curve in the refraction direction BR″. The refraction directions BR′, BR″ of the cylindrical lens pairs 12′, 12″ extend crossing one another at an angle of 90°. A common non-refraction direction NBR″ of the cylindrical lenses 13″ in this case extends in the direction of the x axis and thus parallel to the optical planes OE₁″, OE₂″ and perpendicularly in relation to the optical axis OA. The cylindrical lenses 13″ extend translationally invariantly in the non-refraction direction NBR″ (in this respect, see also FIG. 3). The cylindrical lenses 13″ are arranged one behind another with respect to the optical axis OA. In another embodiment which is not shown, the cylindrical lenses 13a″, 13b″ may also have a curved surface on either side.

The second beam subdivision assembly 3″ furthermore has a spot distance adjusting device 15″ and, in the embodiment shown here, also has a spot intensity adjusting device 16″. The two lenses 13a″, 13b″ are arranged on a common carriage 17″, and in the embodiment shown the first lens 13a″ is arranged stationarily on the common carriage 17″ and the second lens 13b″ can be moved in the y direction by means of the spot distance adjusting device 15″. The spot distance adjusting device 15″ is arranged on the common carriage 17″ for this. The common carriage 17″ (together with the lenses 13a″, 13b″) in turn can be moved in the x direction with respect to the rest of the welding optical unit 1 by way of the spot intensity adjusting device 16″. The spot distance adjusting device 15″ can thus be used to displace the two cylindrical lenses 13″ of the cylindrical lens pair 12″ relative to one another with respect to the refraction direction BR″ (in this case the y direction), and the spot intensity adjusting device 16″ can be used to displace the two cylindrical lenses 13″ of the cylindrical lens pair 12″ with respect to the non-refraction direction NBR″ (in this case the x direction). In the embodiment shown here, the cylindrical lenses 13″ are displaced together by means of the spot intensity adjusting device 16″. In an embodiment which is not shown here, it is also possible for the cylindrical lenses 13a″, 13b″ to be able to be displaced in the x direction individually (it nevertheless being the case that in general the same displacement paths in the x direction are used).

In the embodiment shown here, the adjustment position assumed by the spot distance adjusting device 15″ is a deflection position. The second cylindrical lens 13b″ was displaced from a home position, in which the optical planes OE₁″ and OE₂″ coincide, in the y direction by a length Δy. The optical planes OE₁″, OE₂″ of the cylindrical lenses 13a″, 13b″ are then arranged correspondingly offset by Δy in relation to one another with respect to the refraction direction in FIG. 4. In the embodiment shown here, it is possible to set different deflection positions of the second lens 13b″ with respect to the y direction within an adjustment range of the spot distance adjusting device 15″. The optical planes OE₁″, OE₂″ of the cylindrical lenses 13a″, 13b″ may be at different distances from one another with respect to the refraction direction BR″ corresponding to the respective deflection position of the spot distance adjusting device 15″. The different deflection positions can be set continuously in the embodiment shown here. As an alternative, and not shown here, the different adjustment positions can also be set in discrete steps. The spot distance adjusting device 15″ can furthermore also be used to reach the home position, in which the optical planes OE₁″, OE₂″ of the cylindrical lenses 13a″, 13b″ coincide (not illustrated in more detail here).

In the embodiment shown here, the collimated laser beam 11 impinges on the adjustable beam shaping device 2 in the form of an incident laser beam 10b. The beam cross section 19 of the collimated laser beam 11 (which is already partially shaped when it reaches the cylindrical lens pair 12″) lies completely within the region of the cylindrical lenses 13″ in the direction of the y axis here. The cylindrical lenses 13″ are arranged in the direction of the x axis such that they overlap part of the beam cross section 19 of the collimated laser beam 11. The cylindrical lenses 13″ do not overlap another part of the beam cross section 19 of the collimated laser beam 11 (in this respect, see FIG. 3).

The cylindrical lenses 13′ of the first beam subdivision assembly 3′ are arranged in the direction of the y axis such that they overlap that part 19b′ (the upper part in FIG. 4) of the beam cross section 19 of the collimated laser beam 11 that corresponds to approximately half the beam cross section 19 of the collimated laser beam 11 here. The cylindrical lenses 13′ do not overlap the other part 19a′ (the lower part in FIG. 4) of the beam cross section 19 of the collimated laser beam 11, which corresponds to approximately (the remaining) half of the beam cross section 19 of the collimated laser beam 11 here. A deflected partial beam (20b′ in FIG. 3) results from the upper part 19b′ and an undeflected partial beam (20a′ in FIG. 3) results from the lower part 19a′.

It should be noted that, with the cylindrical lenses 13′ in the home position (where Δx=0), there would be no deflection in the upper part 19b′ of the laser beam 25.

The collimated laser beam 11 is shaped at the beam shaping device 2. Owing to the mutually displaced cylindrical lenses 13a″, 13b″, that part of the collimated (and already partially shaped) laser beam 11 that impinges on the cylindrical lens pair 12″ undergoes a deflection. Here, an angular offset Δβ_{y} corresponding to this deflection is approximately the same as the quotient of the length Δy and the focal length f_{zy1}″ (that is Δβ_{y}≈Δy/f_{zy1}″). Another part of the collimated laser beam 11, which does not impinge on the cylindrical lens pair 12″, remains undeflected (by the cylindrical lens pair 12″). The laser beam 20 shaped in this way correspondingly (in the projection of FIG. 4) comprises two partial beams, specifically the deflected partial beam 20a″ and the undeflected partial beam 20b″. It should be noted that, owing to the already effected (partial) shaping at the first cylindrical lens pair 12′ and the further shaping at the cylindrical lens pair 12″ downstream of the cylindrical lens pair 12″, in fact four partial beams are present.

As already described, the shaped laser beam 20 impinges on the focusing lens 21a in the form of an incident laser beam 10c and is focused in the direction of the workpiece 22 to be welded. The focused, shaped laser beam 20 then generates multiple laser spots, of which two laser spots 23a″, 23b″ can be seen on the surface 22a of the workpiece 22 in the projection of FIG. 4. A spatial offset Δb_{y} between the two laser spots 23a″, 23b″ is approximately the same as the product of the focal length f_{F} and the angular offset Δβ_{y} (that is Δb_{y}=f_{F}·Δβ_{y}=f_{F}·Δy/f_{zy1}″). In the embodiment shown here, it is possible to increase or decrease the spatial offset Δb_{y} by displacing the cylindrical lens 13b″ with respect to the y direction. The spatial offset Δb_{y} between the laser spots 23 then increases or decreases, and the laser spots 23a″, 23b″ move further apart or closer together, corresponding to the displacement.

By virtue of the embodiment shown here, in the situation shown four laser spots 23a′, 23b′, 23a″, 23b″ are generated by the adjustable beam shaping device 2. If in this respect Δx=Δy (with Δx≠0 and Δy≠0) and |f_{zy1}′=|f_{zy1}″ |, the four laser spots have a square arrangement. Alternatively, the adjustable beam shaping device 2 can be adjusted such that only two laser spots 23 are generated (with Δx=0 and Δy≠0, or vice versa) or only one laser spot is generated (with Δx=0 and Δy=0) (these situations are shown here). As a result, it is possible to use the beam shaping device 2 very flexibly.

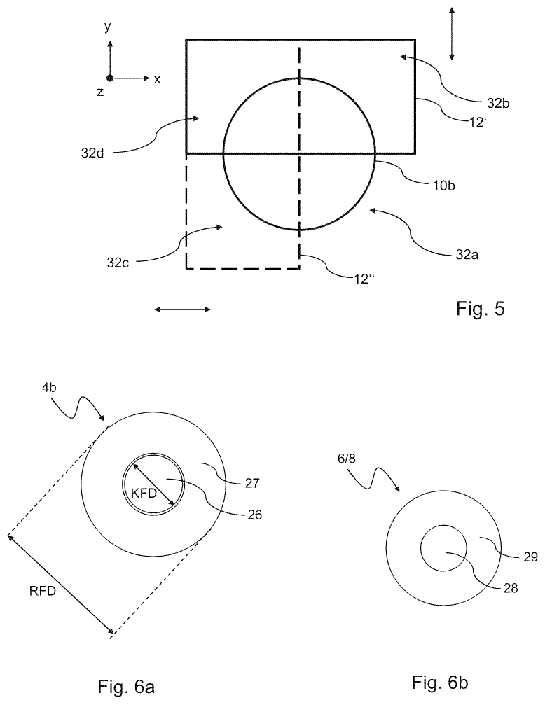

FIG. 5 schematically depicts the closed-loop control of the power distribution, or intensity distribution, of the laser spots using the welding optical unit according to embodiments of the invention from FIG. 3. In FIG. 5, the coordinate system is aligned such that the x axis points to the right, the y axis points upward, and the z axis points out of the plane of the drawing.

The first cylindrical lens pair 12′ of the first beam subdivision assembly is illustrated here in simplified form as a rectangle by a solid line, and the second cylindrical lens pair 12″ is illustrated here in simplified form as a rectangle by a dashed line. The first cylindrical lens pair 12′ generates a beam deflection with respect to the x direction, and the second cylindrical lens pair 12″ generates a beam deflection with respect to the y direction.

Here, the two cylindrical lens pairs 12′, 12″ form four zones 32a, 32b, 32c, 32d corresponding to their local overlaps with one another. In zone 32a, the incident laser beam 10b is not deflected by the cylindrical lens pairs 12′, 12″; in zone 32b, the incident laser beam 10b is deflected by the cylindrical lens pair 12′; in zone 32c, the incident laser beam 10b is deflected by the cylindrical lens pair 12″; and in zone 32d, the incident laser beam 10b is deflected by both cylindrical lens pairs 12′, 12″. Correspondingly, in this case four partial beams, or four laser spots, are generated from the incident laser beam 10b. In the situation shown in FIG. 5, the incident laser beam 10b is arranged relative to the cylindrical lens pairs 12′, 12″ such that its area of overlap with each of the four zones 32a, 32b, 32c, 32d is the same size here. As a result, the intensity of each of the four laser spots generated is the same.

By displacing the cylindrical lens pairs 12′, 12″ relative to the incident laser beam 10b (which is received stationarily here), the overlap of the incident laser beam 10b with the zones 32a, 32b, 32c, 32d can be modified in pairs and thus the intensity of the associated laser spots can be modified in pairs. The cylindrical lens pair 12′ can be moved in the y direction by means of its spot intensity adjusting device, and the cylindrical lens pair 12″ can be moved in the x direction by means of its spot intensity adjusting device.

If, for example, the cylindrical lens pair 12′ is displaced in the positive y direction, the areas of overlap of the incident laser beam 10b with the zones 32a and 32c become larger, and the intensity of the laser spots generated by the zones 32a and 32c increases. Conversely, the areas of overlap of the incident laser beam 10b with the zones 32b and 32d decrease, and the intensity of the laser spots generated by the zones 32b and 32d decreases.

If, for example, the cylindrical lens pair 12″ is also displaced in the positive x direction, the overlap areas of the incident laser beam 10b with the zones 32c and 32d become larger, and the intensity of the laser spots generated by the zones 32c and 32d increases. Conversely, the areas of overlap of the incident laser beam 10b with the zones 32a and 32b decrease, and the intensity of the laser spots generated by the zones 32a and 32b decreases.

FIG. 6a shows a schematic illustration, in cross section, of an exemplary 2-in-1 fiber 4b as can be used as a fiber-optic cable and source for the output laser beam for the welding optical unit in FIGS. 1-4.

The 2-in-1 fiber 4b comprises a core fiber 26 with a core fiber diameter KFD and a ring fiber 27 with a ring fiber diameter RFD. The 2-in-1 fiber makes it possible to generate a preshaped laser beam which has a core portion and a ring portion (in this respect, see FIG. 6b) and serves as output laser beam in the welding optical unit. To this end, an original laser beam (not shown in more detail) is fed partially into the core fiber 26 and partially into the ring fiber 27, for example via an optical wedge pushed partially in the original laser beam. If the original laser beam is introduced only into the core fiber 26 (that is, a power proportion of 0% is selected in the ring fiber 27), it is also possible to generate a non-preshaped laser beam by means of the 2-in-1 fiber 4b.

FIG. 6b shows a schematic illustration, in cross section, of the output laser beam 6 as can be generated by the exemplary 2-in-1 fiber from FIG. 6a.

The output laser beam 6 is a preshaped laser beam 8 and has the core portion 28 and the ring portion 29. The ring portion 29 surrounds the core portion 28. It should be noted that a mean laser intensity is generally higher in the core portion 28 than in the ring portion 29, usually by a factor of at least four.

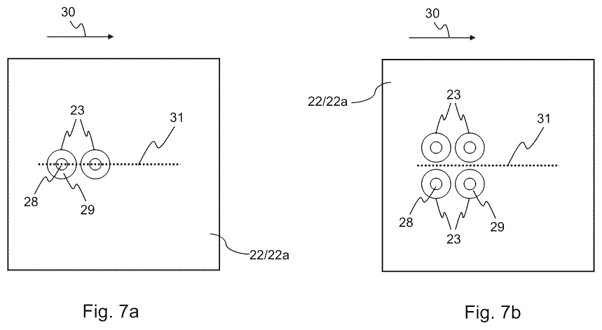

FIG. 7a shows, by way of example for the embodiment of FIGS. 1 and 2 and in a schematic plan view of the surface 22a of the workpiece 22, two laser spots 23 of the shaped laser beam, each having a core portion 28 and a ring portion 29, on the surface 22a of the workpiece 22.

The laser spots 23 are moved over the surface 22a of the workpiece 22 along a welding contour 31 with respect to a feed direction 30. The laser spots 23 are arranged one behind another with respect to the feed direction 30 in this case.

The arrangement of the laser spots 23 that is shown here can be used to perform direction-dependent welding. The arrangement shown here can be used, for example, for profile welding in the case of aluminum materials.

While the welding contour 31 is being traversed, the adjustment position of the spot distance adjusting device of the one beam subdivision assembly can be adjusted, with the result that the laser spots 23 move closer to or further away from one another. Moreover, the spot intensity adjusting device can be used to adjust the intensity of the individual laser spots 23 while the welding contour 31 is being traversed.

As an alternative or in addition, the adjustment positions of the spot distance adjusting device and the spot intensity adjusting device of the one beam subdivision assembly can also be adjusted between the welding operations for two components, in particular if the types of the components to be welded change.

FIG. 7b shows, by way of example for the embodiment of FIGS. 3 and 4 and in a schematic plan view of the surface 22a of the workpiece 22, four laser spots 23 of a shaped laser beam 20, each having a core portion 28 and a ring portion 29, on the surface 22a of the workpiece 22.

The laser spots 23 are moved over the surface 22a of the workpiece 22 along its welding contour 31 with respect to a feed direction 30. Here, the laser spots 23 are in a square arrangement. For the feed direction 30 shown, here two laser spots 23 are leading laser spots and two laser spots 23 are trailing laser spots.

The arrangement of the laser spots 23 that is shown here can be welded largely direction-independently; even if temporarily (for example along a curve of the welding contour) with respect to the (local) feed direction one laser spot is a leading laser spot, two laser spots are arranged in the middle and one laser spot is a trailing laser spot, the welding behavior changes very little. The arrangement shown here can be used, for example, for direction-independent welding in the case of aluminum materials.

While the welding contour 31 is being traversed, the adjustment positions of the spot distance adjusting devices of the two beam subdivision assemblies can be adjusted, with the result that the laser spots 23 move closer to or further away from one another. Moreover, the spot intensity adjusting devices can be used to adjust the intensity of the laser spots 23 while the welding contour 31 is being traversed. It is possible to set the respective distances between and intensities of the laser spots 23 in pairs.

As an alternative or in addition, the adjustment positions of the spot distance adjusting device and the spot intensity adjusting device of the two beam subdivision assemblies can also be adjusted between the welding operations for two components, in particular if the types of the components to be welded change.

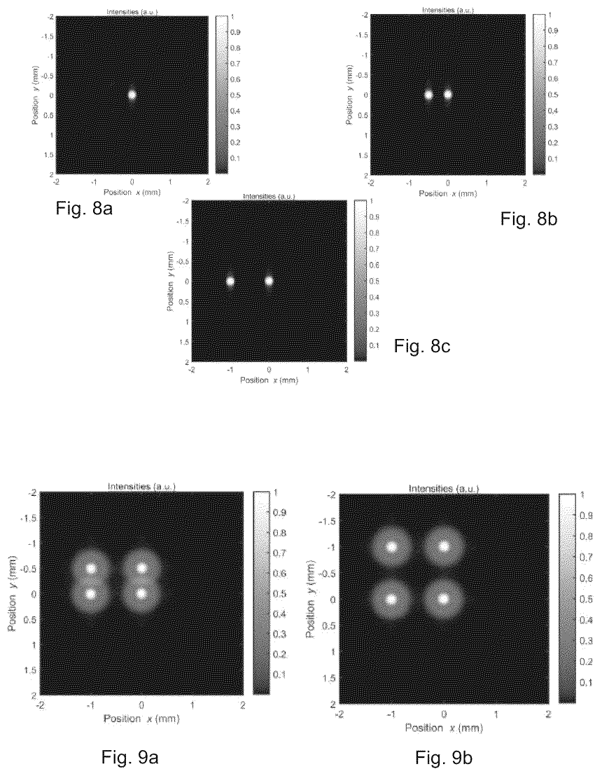

FIG. 8a shows an image, from an experiment, of a single laser spot generated by the welding optical unit according to embodiments of the invention. In the present example, a welding optical unit similar to that described in FIG. 3 was used. However, a single fiber was used as source for the output laser beam. The focal length f_{F} of the focusing lens was 500 mm, the focal length f_{zy1}′ of the first cylindrical lens of the first beam subdivision assembly was 2000 mm and the focal length f_{zy1}″ of the second cylindrical lens of the second beam subdivision assembly was likewise 2000 mm. Δx and Δy were each 0 mm, and therefore the beam subdivision assemblies were in the home position. In the home position, only a single laser spot is generated.

FIG. 8b shows an image, from an experiment, of two laser spots generated by the welding optical unit according to embodiments of the invention. In the present example, a welding optical unit similar to that described in FIG. 3 was used. However, a single fiber was used as source for the output laser beam. The focal length f_{F} of the focusing lens was 500 mm, the focal length f_{zy1}′ of the first cylindrical lens of the first beam subdivision assembly was 2000 mm and the focal length f_{zy1}″ of the second cylindrical lens of the second beam subdivision assembly was likewise 2000 mm. Δx was 2 mm and Δy was 0 mm, and the first beam subdivision assembly was thus in a deflection position and the second beam subdivision assembly was in the home position. Two laser spots with a spatial offset Δbₓ of approximately 0.5 mm were generated.

FIG. 8c shows an image, from an experiment, of two laser spots generated by the welding optical unit according to embodiments of the invention. In the present example, a welding optical unit similar to that described in FIG. 3 was used. However, a single fiber was used as source for the output laser beam. The focal length f_{F} of the focusing lens was 500 mm, the focal length f_{zy1}′ of the first cylindrical lens of the first beam subdivision assembly was 2000 mm and the focal length f_{zy1}″ of the second cylindrical lens of the second beam subdivision assembly was likewise 2000 mm. Δx was 4 mm and Δy was 0 mm, and the first beam subdivision assembly was thus in a deflection position and the second beam subdivision assembly was in the home position. Two laser spots with a spatial offset Δbₓ of approximately 1 mm were generated.

FIG. 9a shows an image, from an experiment, of laser spots generated by the welding optical unit according to embodiments of the invention. In the present example, a welding optical unit like that described in FIG. 3 was used. A 2-in-1 fiber was used as source for the output laser beam. The laser spots accordingly have a core portion and a ring portion. The focal length f_{F} of the focusing lens was 500 mm, the focal length f_{zy1}′ of the first cylindrical lens of the first beam subdivision assembly was 2000 mm and the focal length f_{zy1}″ of the second cylindrical lens of the second beam subdivision assembly was likewise 2000 mm. Δx was 4 mm and Δy was 2 mm, and therefore both beam subdivision assemblies were in a deflection position. Four laser spots were generated with a spatial offset Δbₓ of approximately 1 mm and a spatial offset Δb_{y} of approximately 0.5 mm. The four laser spots are arranged in a rectangle and the ring portions of the laser spots overlap in the y direction, but not in the x direction.

FIG. 9b shows an image, from an experiment, of laser spots generated by the welding optical unit according to embodiments of the invention. In the present example, a welding optical unit like that described in FIG. 3 was used. A 2-in-1 fiber was used as source for the output laser beam. The laser spots accordingly have a core portion and a ring portion. The focal length f_{F} of the focusing lens was 500 mm, the focal length f_{zy1}′ of the first cylindrical lens of the first beam subdivision assembly was 2000 mm and the focal length f_{zy1}″ of the second cylindrical lens of the second beam subdivision assembly was likewise 2000 mm. Δx was 4 mm and Δy was 4 mm, and therefore both beam subdivision assemblies were in a deflection position. Four laser spots were generated with a spatial offset Δbₓ of approximately 1 mm and a spatial offset Δb_{y} of approximately 1 mm. The four laser spots are arranged in a square and the ring portions of the laser spots do not overlap.

As described above, embodiments of the invention relate to a welding optical unit (1) for a laser beam (25) for the laser welding of workpieces (22), comprising an adjustable beam shaping device (2), which makes it possible to generate one beam or multiple partial beams (20a; 20a′; 20a″; 20b; 20b′; 20b″), and correspondingly one or more laser spots (23; 23a; 23a′; 23a″; 23b; 23b′; 23b″), from an incident laser beam (10b) depending on the adjustment, wherein
the beam shaping device (2) comprises at least one beam subdivision assembly (3; 3′, 3″) having:
a cylindrical lens pair (12; 12′; 12″), comprising two cylindrical lenses (13; 13a; 13a′; 13a″; 13b; 13b′; 13b″) which are arranged one behind the other and have diametrically opposite focal lengths and mutually parallel optical planes (OE₁; OE₁′; OE₁″; OE₂; OE₂′; OE₂″),
the two cylindrical lenses extending with a curve on at least one side with respect to a common refraction direction (BR; BR′; BR″), which is perpendicular to the optical planes, and extending translationally invariantly with respect to a common non-refraction direction (NBR; NBR′; NBR″), which extends parallel to the optical planes,
and a spot distance adjusting device (15; 15′; 15″), which makes it possible to displace the two cylindrical lenses relative to one another with respect to the refraction direction. The welding optical unit can be used to easily and flexibly shape a beam, and in particular to flexibly set a number of and a distance between generated laser spots.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Welding optical unit
2 Beam shaping device
3 Beam subdivision assembly
3′ First beam subdivision assembly
3″ Second beam subdivision assembly
4 Fiber-optic cable
4a Multifiber
4b 2-in-1 fiber
Source
6 Output laser beam
7 Fiber end
8 Preshaped laser beam
9 Collimation device
9a Collimation lens
10a Incident laser beam (on the collimation device)
10b Incident laser beam (on the beam shaping device)
10c Incident laser beam (on the focusing device)
11 Collimated laser beam
12 Cylindrical lens pair
12′ Cylindrical lens pair (first beam subdivision assembly)
12″ Cylindrical lens pair (second beam subdivision assembly)
13 Cylindrical lenses
13′ Cylindrical lenses (first beam subdivision assembly)
13″ Cylindrical lenses (second beam subdivision assembly)
13a First cylindrical lens
13a′ First cylindrical lens (first beam subdivision assembly)
13a″ First cylindrical lens (second beam subdivision assembly)
13b Second cylindrical lens
13b′ Second cylindrical lens (first beam subdivision assembly)
13b″ Second cylindrical lens (second beam subdivision assembly)
14a Curved surface of the first cylindrical lens
14a′ Curved surface of the first cylindrical lens (first beam subdivision assembly)
14a″ Curved surface of the first cylindrical lens (second beam subdivision assembly)
14b Curved surface of the second cylindrical lens
14b′ Curved surface of the second cylindrical lens (first beam subdivision assembly)
14b″ Curved surface of the second cylindrical lens (second beam subdivision assembly)
15 Spot distance adjusting device
15′ Spot distance adjusting device (first beam subdivision assembly)
15″ Spot distance adjusting device (second beam subdivision assembly)
16 Spot intensity adjusting device
16′ Spot intensity adjusting device (first beam subdivision assembly)
16″ Spot intensity adjusting device (second beam subdivision assembly)
17 Common carriage
17′ Common carriage (first beam subdivision assembly)
17″ Common carriage (second beam subdivision assembly)
19 Beam cross section
19a, 19b Part (of the beam cross section)
19a′, 19b′ Part (of the beam cross section, first beam subdivision assembly)
19a″, 19b″ Part (of the beam cross section, second beam subdivision assembly)
Shaped laser beam
20a Undeflected partial beam
20a′ Undeflected partial beam (behind first beam subdivision assembly)
20a″ Undeflected partial beam (behind second beam subdivision assembly)
20b Deflected partial beam
20b′ Deflected partial beam (behind first beam subdivision assembly)
20b″ Deflected partial beam (behind second beam subdivision assembly)
21 Focusing device
21a Focusing lens
22 Workpiece
22a Surface
23 Laser spots
23a Laser spot
23a′ Laser spot
23a″ Laser spot
23b Laser spot
23b′ Laser spot
23b″ Laser spot
24 Beam path
Laser beam
26 Core fiber
27 Ring fiber
28 Core portion
29 Ring portion
Feed direction
31 Welding contour
32a-32d Zones
BR Common refraction direction
BR′ Common refraction direction (first beam subdivision assembly)
BR″ Common refraction direction (second beam subdivision assembly)
KFD Core fiber diameter
NBR Common non-refraction direction (first beam subdivision assembly)
NBR′ Common non-refraction direction (second beam subdivision assembly)
OA Optical axis (of the welding optical unit)
OE₁ Optical plane of the first cylindrical lens
OE₁′ Optical plane of the first cylindrical lens (first beam subdivision assembly)
OE₁″ Optical plane of the first cylindrical lens (second beam subdivision assembly)
OE₂ Optical plane of the second cylindrical lens
OE₂′ Optical plane of the second cylindrical lens (first beam subdivision assembly)
OE₂″ Optical plane of the second cylindrical lens (second beam subdivision assembly)
RFD Ring fiber diameter
Δb Spatial offset
Δbₓ Spatial offset in x (first beam subdivision assembly)
Δb_{y} Spatial offset in y (second beam subdivision assembly)
Δx Length (of the displacement of the cylindrical lens in x)
Δy Length (of the displacement of the cylindrical lens in y)
Δβ Angular offset
Δβₓ Angular offset (first beam subdivision assembly)
Δβ_{y} Angular offset (second beam subdivision assembly)

1. A welding optical unit for a laser beam for laser welding of workpieces, the welding optical unit comprising:
a source for providing a laser beam,
a collimator for collimating the laser beam incident thereon,
a focusing device for focusing the laser beam incident thereon toward a workpiece to be welded, and
an adjustable beam shaper configured to shape the laser beam incident thereon into a shaped laser beam, wherein the shaped laser beam comprises one beam or multiple partial beams depending on an adjustment of the beam shaper, and correspondingly forms one or multiple laser spots on the workpiece to be welded,
wherein the beam shaper is arranged in a beam path of the laser beam between the collimator and the focusing device;
wherein the beam shaper comprises at least one beam subdivision assembly, the at least one beam subdivision assembly comprising:
a cylindrical lens pair comprising two cylindrical lenses with diametrically opposite focal lengths and mutually parallel optical planes,
wherein the two cylindrical lenses are arranged one behind the other with respect to an optical axis of the welding optical unit,
wherein the two cylindrical lenses of the cylindrical lens pair extend with a curve on at least one side with respect to a common refraction direction perpendicular to the optical planes, and extend translationally invariantly with respect to a common non-refraction direction parallel to the optical planes, and
wherein the refraction direction and the non-refraction direction extend perpendicularly to the optical axis of the welding optical unit,
the welding optical unit further comprising a spot distance adjusting device configured to displace the two cylindrical lenses of the cylindrical lens pair relative to one another with respect to the refraction direction.

2. The welding optical unit as claimed in claim 1, wherein the beam shaper comprises two beam subdivision assemblies,
and wherein the refraction directions of the two cylindrical lens pairs of the two beam subdivision assemblies extend crossing one another.

3. The welding optical unit as claimed in claim 2, wherein the refraction directions of the two beam subdivision assemblies cross at an angle of 90°.

4. The welding optical unit as claimed in claim 1, wherein the two cylindrical lenses of the cylindrical lens pair overlap part of a beam cross section of the collimated laser beam, and does not overlap another part of the beam cross section of the collimated laser beam.

5. The welding optical unit as claimed in claim 1, wherein, in the at least one beam subdivision assembly, the spot distance adjusting device is capable of assuming at least the following adjustment positions:
a home position, in which the optical planes of the two cylindrical lenses of the cylindrical lens pair coincide, and
a deflection position, in which the optical planes of the two cylindrical lenses of the cylindrical lens pair are arranged offset in relation to one another with respect to the refraction direction.

6. The welding optical unit as claimed in claim 5, wherein the spot distance adjusting device is capable of assuming multiple different deflection positions, in which the optical planes of the two cylindrical lenses are arranged offset in relation to one another to different extents with respect to the refraction direction.

7. The welding optical unit as claimed in claim 6, wherein the spot distance adjusting device is configured to continuously set the different deflection positions in an adjustment range.

8. The welding optical unit as claimed in claim 1, wherein the at least one beam subdivision assembly further comprises:
a spot intensity adjusting device configured to displace the two cylindrical lenses of the cylindrical lens pair with respect to the non-refraction direction.

9. The welding optical unit as claimed in claim 8, wherein the two cylindrical lenses of the cylindrical lens pair are arranged on a common carriage, the common carriage being movable by the spot intensity adjusting device on the welding optical unit with respect to the non-refraction direction, and wherein one of the two cylindrical lenses is movable by the spot distance adjusting device on the common carriage with respect to the refraction direction.

10. The welding optical unit as claimed in claim 1, wherein the source for providing the laser beam comprises a fiber end of a multifiber, from which the laser beam emerges in a form of a preshaped laser beam with a core portion and a ring portion.

11. The welding optical unit as claimed in claim 10, wherein the multifiber is a 2-in-1 fiber.

12. The welding optical unit as claimed in claim 1, wherein the collimator comprises a collimation lens.

13. The welding optical unit as claimed in claim 1, wherein the focusing device comprises a focusing lens.

14. A method of laser welding using a welding optical unit as claimed in claim 1, the method comprising:
providing a laser beam using the source,
focusing the laser beam toward a workpiece using the focusing device,
traversing the laser beam along a welding contour on the workpiece, and
while the welding contour is being traversed, adjusting an adjustment position of the spot distance adjusting device in the at least one beam subdivision assembly.

15. The method as claimed in claim 14, wherein
the at least one beam subdivision assembly further comprises:
a spot intensity adjusting device configured to displace the two cylindrical lenses of the cylindrical lens pair with respect to the non-refraction direction,
the method further comprising, while the welding contour is being traversed, adjusting an adjustment position of the spot intensity adjusting device.

16. The method as claimed in claim 14, wherein
different workpieces are welded one after another using the welding optical unit,
and wherein the adjustment position of the spot distance adjusting device is adjusted between welding of the different workpieces.

17. The method as claimed in claim 16, wherein the at least one beam subdivision assembly further comprises:
a spot intensity adjusting device configured to displace the two cylindrical lenses of the cylindrical lens pair with respect to the non-refraction direction, and wherein an adjustment position of the spot intensity adjusting device is adjusted between welding of the different workpieces.
